(19) United States
(12) Patent Application Publication
(10) Pub. No.: US 2010/0180780 A1
(43) Pub. Date: Jul. 22, 2010

(54) APPARATUS FOR THE MANUAL CUTTING OF FOODS

(75) Inventor: Joerg Beckmann, Hildesheim (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: HAPE GMBH, Hannover (DE)

(21) Appl. No.: 12/691,054

(22) Filed: Jan. 21, 2010

(30) Foreign Application Priority Data
Jan. 22, 2009 (DE) 20 2009 000 833.9

(51) Int. Cl. A47J 43/25; B02C 17/02; A47J 43/00

(52) U.S. Cl. 99/537; 241/95; 241/168; 241/273.1

(57) ABSTRACT

An apparatus for the manual cutting of foods includes a first basic element and a second basic element, wherein the first and second basic elements are pivotably movable relative to one another about a pivot axis from a non-usage setting into a work setting, wherein the first and second basic elements each have a front side and a rear side, each of the front and rear sides having a functional surface configured as a guideway and as a cutting zone for food, and wherein the first and second basic elements lie one against the other in the non-usage setting. The apparatus also has an integrated latching device disposed in a region of the pivot axis configured to secure defined angular settings of the first and second basic elements.

Priority is claimed to German Patent Application No. DE 20 2009 000 833.9, filed on Jan. 22, 2009, the entire disclosure of which is incorporated by reference herein.

The invention relates to an apparatus for the manual cutting of foods, comprising two basic elements, which are pivotably movable relative to one another about a pivot axis from a non-usage setting into a work setting, and an integrated latching device in the region of the pivot axis, for securing defined angular settings of the basic elements, each basic element having on its front side and on its rear side, as a guideway, functional surfaces realized as a cutting zone for the food.

### BACKGROUND

Apparatuses of this type are known as cutting tools for kitchen use in a variety of forms, for example in the form of graters. These consist of a plate-shaped basic element made of metal or plastic, which on one side forms a guideway for the food to be treated, in the course of which guideway there is arranged a cutting zone. The cutting zone consists of an areal, uniform distribution of individual cutting profiles projecting from the plane of the basic element. Each cutting profile is characterized by a recess in the basic element and a, in particular convex, cutting edge, which extends above the said recess and is arranged to penetrate into the food moved along the guideway, so that in the region of each cutting edge a cutting clearance geometry is obtained which is defined by the said recess and from whose dimensions and form derives the shape of the cut material stripped from the food during the cutting motion.

An apparatus of the generic type is known, for example, from DE 20 2007 006 186 U1, which apparatus serves the manual cutting of foods with at least one cutting zone. Two basic elements, which are joined together at one end pivotably about an axis and can be fixed relative to one another in defined angular settings about the axis, are here equipped with different cutting profiles. The defined angular setting is here ensured, according to one embodiment, by a spacer, which by means of pins connects those end regions of the basic elements which are facing away from the axis. The cutting zone of at least one basic element can here be provided with recesses, to which, on the top side and the bottom side, cutting profiles are assigned.

Furthermore, an apparatus of the generic type is also already known from CH 356877, which describes a cutting apparatus for vegetables and the like. The apparatus has two housing parts, which are pivotably movable relative to one another about a pivot axis from a non-usage setting into a work setting and which in the elongated work setting, just as in their collapsed non-usage setting, can be secured in their setting by means of an integrated latching device in the region of the pivot axis by way of catches or snap locks.

U.S. Pat. No. 5,312,054 A also already discloses a free-standing, V-shaped apparatus for the cutting of foods, comprising two basic elements with different cutting profiles, which basic elements are pivotably movable relative to one another about a pivot axis from a non-usage setting into a work setting, and comprising means for securing defined angular settings of the basic elements.

U.S. Pat. No. 989,896 relates to an apparatus for the manual cutting of foods, comprising two basic elements, which are pivotably movable relative to one another about a pivot axis, and a cutting zone for the food on a front side as well as on a rear side.

From U.S. Pat. No. 149,259, a folding apparatus for the manual cutting of foods, comprising two pivotably movable basic elements, is likewise already known, each basic element being realized as a guideway with a cutting zone for the food.

### SUMMARY OF THE INVENTION

An aspect of the invention is to provide a facility for creating an easily operable and universally usable apparatus. In particular, the adjustment of the work setting should be simplified and the cleaning facilitated.

According to the invention, an apparatus is provided, in which a non-usage setting, in which the basic elements lie one against the other, as well as at least two work settings, in which the basic elements respectively form between them an acute angle, can be secured by the axially actuable latching device, in the first work setting the respective front sides and in the second work setting the respective rear sides of the two basic elements pointing outwards. The user can hence easily select the one of the three possible settings which is respectively desired, by firstly, through actuation, in particular, of a press button or slide in the axial direction, suspending the latching function, and then pivoting the two basic elements selectively in opposite pivot directions until the respective work setting is reached. The basic elements hereupon latch automatically in the predetermined angular setting, so that an erroneous actuation of the apparatus is virtually precluded. The securability of the apparatus in two work settings provides a variety of usage options, by virtue of maximally four different cutting zones or functional surfaces in total. Self-evidently, not all functional surfaces have to have a cutting function. Furthermore, the respective functional surfaces can be active in both directions, in order thus to increase the efficiency of the functional surfaces.

In this context, it proves particularly expedient in practice if the acute angle which is respectively formed between the front sides and rear sides of the basic elements in the two work settings is consistent. As a result of this, the external dimensions, in particular, therefore, the angle of inclination of the functional surfaces in the two work settings, do not fundamentally change, so that in particular the collection area for the cut food, which is enclosed between the basic elements, is maintained.

Furthermore, a modification of the present invention, in which each basic element has different functional surfaces on the front side and the rear side, allows a problem-free utilization of the respectively suitable functional surface, without the functional surfaces having to be exchanged for this purpose. Rather, the user can select between four usable functional surfaces without any additional effort.

It is here particularly expedient if, according to a further embodiment, the functional surfaces of the front side and/or rear side of one basic element differ from the front side and/or rear side of the other basic element, in order thus to further improve the utility of the apparatus.

Preferably, the functional surfaces of the front side and rear side are formed by a plate having two-sided cutters, wherein the cutting geometries or cutter configurations are differently realized and are produced in a single work operation, for example by etching.

Another, likewise particularly promising refinement is achieved by the latching device having an axially movable latching element, which positively secures the non-usage setting as well as the work settings. An extremely compact structure of the latching device is hence realizable, which on the one hand does not impair its appearance and on the other hand allows it to be actuated intuitively, for the user, in the direction of the pivot axis. The latching element enters, in accordance with its axial position, into positive engagement with a corresponding counterstay, which positive engagement is interrupted for the adjustment of the work setting.

In this context, it proves particularly sensible if the latching element is movable in the axial direction, by means of a manually actuable pressure element, counter to the pretensioning force of a spring element. The pressure element, for example a push button, which is designed for this purpose in a haptically optimized manner, thus allows a conceivably simple operation. The pressure element can be accentuated, moreover, by its shape, as well as by its colouring, in order to make its operation still more conspicuous. A mere pressure actuation releases the latching element in order to alter the setting of the basic elements.

It is here particularly practical if the pressure element is rotationally symmetric in its design and is disposed coaxially to the pivot axis, so that the pressure element can be effortlessly integrated into the region of the end face of the pivot axis or replaces this end face.

An unintentional actuation is here prevented by the fact that the pressure element, at the periphery, is radially enclosed by an end portion of the second basic element, so that the pressure element cannot be actuated accidentally and is frontally enclosed in a substantially contour-flush or surface-flush manner by the end portion of the second basic element. At the same time, the penetration of dirt particles or food remnants is thereby easily prevented, so as thus to facilitate the cleaning of the apparatus.

Rather, the pressure element in its rest position does not project or projects only slightly in relation to the end portion of the second basic element and in its actuation position springs back in relation to the end portion of the second basic element. A sufficient actuating force, in conjunction with a defined actuating direction, is hence necessary to achieve the actuating position, so that reliability in handling is improved and an unintentional actuation is prevented.

The latching element could be made radially movable and could be realized, for example, as a pawl in order to fix the basic elements in their desired angular setting. On the other hand, it is particularly promising if the latching element is connected to the first basic element such that it is axially movable and rotationally fixed in relation to the pivot axis and, in the non-usage setting as well as in the work settings, enters into a positive connection with shape-outs of the second basic element. Here a first axial position corresponds to the positive connection, whilst a second axial position leads to a disengagement of the latching element and the shape-out and thus to the unobstructed execution of a relative pivot motion. The rotationally fixed arrangement in relation to the first basic element here leads to a securement of the second basic element, having the shape-out, in the non-usage setting and in the work settings.

In this context, it proves particularly practical if the latching element has a plurality of recesses and the shape-out is realized as a latching boss, which thus allows a simple adaptation of the work settings to a predetermined angular setting.

In principle, a single latching device is sufficient to secure the angular settings. On the other hand, an embodiment is practical, in which the apparatus is equipped with two latching devices at opposite ends of the pivot axis, the respective latching element being actuable by a compressive force acting in opposite directions, so that the user can actuate the two latching devices without difficulty, with just one hand, by compressing the two pressure elements between thumb and index finger and thereby releasing both latching elements.

### BRIEF DESCRIPTION OF THE DRAWINGS

The invention permits various embodiments. For further illustration of its basic principle, one of these is represented in the drawing and is described below. This drawing shows, respectively in perspective view, in FIG. 1 an apparatus for the cutting of foods in a non-usage setting;

FIG. 2 the apparatus shown in FIG. 1 during the pivot motion into a first work setting;

FIG. 3 the apparatus shown in FIG. 1 in a second work setting;

FIG. 4 a detail of an integrated latching device of the apparatus in the non-usage setting;

FIG. 5 a partially cut representation of the integrated latching device in a work setting during actuation of the pressure element.

### DETAILED DESCRIPTION

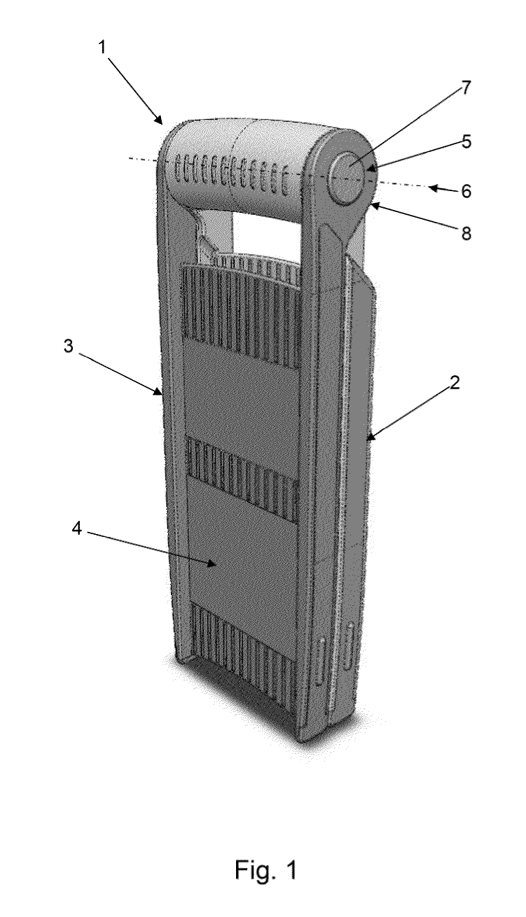

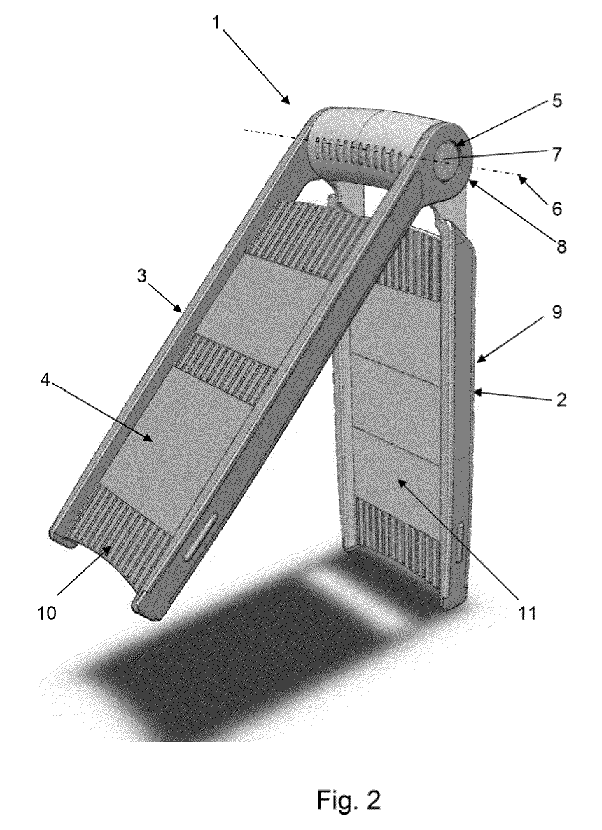

FIG. 1 shows an apparatus 1 for the manual cutting of foods, comprising two basic elements 2, 3, which are pivotably movable relative to one another and which, in the represented non-usage setting, lie flat one against the other and thereby require just a small stowage space. Each basic element 2, 3 forms at the same time a guideway for the food, with a functional surface 4 having a cutting zone. The apparatus 1 is equipped with an integrated latching device 5 in the region of a pivot axis 6 for the securement of both the shown non-usage setting and the work settings (evident in FIGS. 2 and 3) of the basic elements 2, 3. A pressure element 7 of the latching device 5, which is intended for the release of the latching position and is radially enclosed at the periphery by an end portion 8 of the second basic element 3, projects in its rest position slightly beyond this end portion 8, so that an unintentional actuation is virtually precluded.

FIGS. 2 and 3 show different work settings, in FIG. 2 the apparatus 1 being represented in an actuation position of the pressure element 7 during the pivot motion of the basic elements 2, 3 about a pivot axis 6 into a first work setting. In this actuating position of the pressure element 7, the latter retreats in relation to the end portion 8 of the second basic element 3. The pressure element 7, which is here realized as a push button, maintains the recoil position until such time as the latching device 5 latch-locks in the predetermined work setting under the influence of the pretensioning force of a spring element (not shown). In this first work setting, the respective front sides 9, 10 of the two basic elements 2, 3 point outwards, so that the corresponding functional surfaces 4 can be utilized.

By contrast, in FIG. 3 the apparatus 1 shown in FIG. 1 is represented in a second work setting, in which the respective rear sides 11, 12 of the two basic elements 2, 3 point outwards. In the shown position, the predetermined angular setting between the basic elements 2, 3 is already reached, so that the pressure element 7 is returned into the slightly projecting rest position evident in FIG. 1. Starting from the non-usage setting shown in FIG. 1, the two work settings are reached, in accordance with FIG. 2 or 3, by mutual pivoting of the basic elements 2, 3 by the same angular amount.

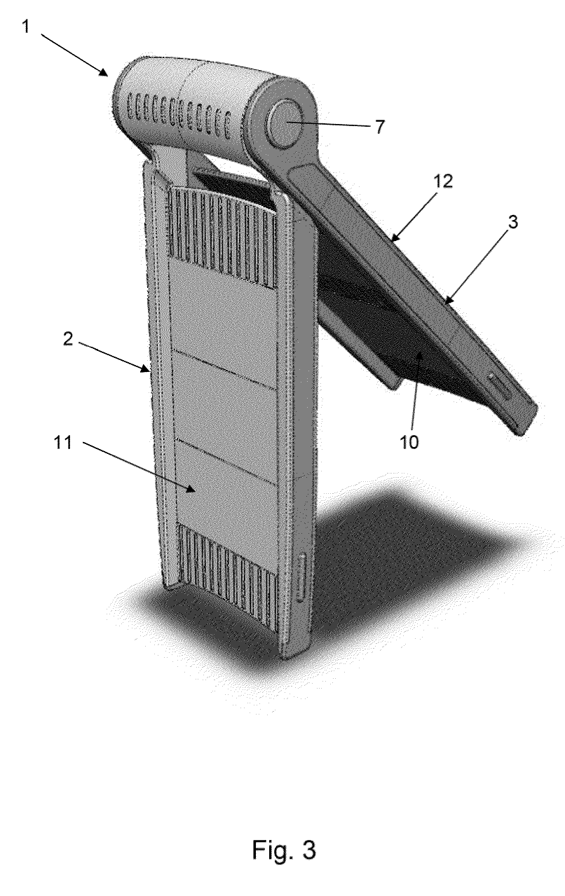

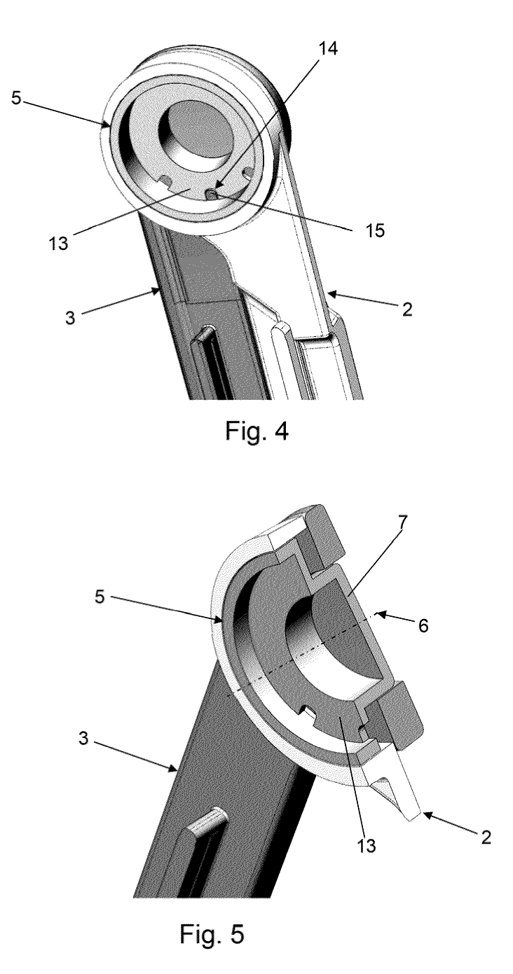

The working method of the integrated latching device 5 of the apparatus 1 is illustrated once again with reference to FIGS. 4 and 5, FIG. 4 showing the non-usage setting in accordance with FIG. 1 and FIG. 5 showing an actuating position of the latching device 5 during the pivot motion in accordance with FIG. 2. The latching device 5 has for this purpose an axially movable latching element 13, which positively secures the non-usage setting as well as the work settings and is displaceable in the direction of the pivot axis 6, counter to the pretensioning force of a spring element (not shown), by means of the manually actuable pressure element 7. The latching element 13 is here positively connected to the first basic element 2 such that it is axially movable and rotationally fixed in relation to the pivot axis 6. Furthermore, the latching element 13 is, in the non-usage setting as well as in the work settings, positively connected to the first basic element 2 by means of a plurality of shape-out 14, realized as a recess, in which a latching boss 15 of the second basic element 3 engages.

What is claimed is:

1. An apparatus for the manual cutting of foods comprising:
a first basic element;
a second basic element, wherein the first and second basic elements are pivotably movable relative to one another about a pivot axis from a non-usage setting into a work setting, wherein the first and second basic elements each have a front side and a rear side, each of the front and rear sides having a functional surface configured as a guideway and as a cutting zone for food, and wherein the first and second basic elements lie one against the other in the non-usage setting; and
an integrated latching device disposed in a region of the pivot axis configured to secure defined angular settings of the first and second basic elements, wherein in a first work setting, the first and second basic elements are disposed at a first acute angle with respect to each other and the front sides of the first and second basic elements point outwards and, in a second work setting, the first and second basic elements are disposed at a second acute angle with respect to each other and the rear sides of the first and second basic elements point outwards.

2. The apparatus as recited in claim 1, wherein the first acute angle and the second acute angle are of equal magnitude.

3. The apparatus as recited in claim 1, wherein the first and second basic elements each include different functional surfaces on the front sides and the rear sides.

4. The apparatus as recited in claim 1, wherein the functional surfaces of the first basic element differ from the functional surfaces of the second basic element.

5. The apparatus as recited in claim 1, wherein a plate having two-sided cutters forms the functional surfaces of the front and rear sides of the second basic element.

6. The apparatus as recited in claim 1, wherein the integrated latching device includes an axially movable latching element configured to positively secure the non-usage and the work settings.

7. The apparatus as recited in claim 6, further comprising a manually actuatable pressure element configured to move the latching element in an axial direction counter to a pretensioning force of a spring element.

8. The apparatus as recited in claim 7, wherein the manually actuatable pressure element is rotationally symmetric and disposed coaxially to the pivot axis.

9. The apparatus as recited in claim 7, wherein the second basic element includes an end portion radially enclosing the manually actuatable pressure element at a periphery.

10. The apparatus as recited in claim 9, wherein the manually actuatable pressure element does not project or projects slightly relative to the end portion in a rest position and is configured to spring back relative to the end portion in an actuation position.

11. The apparatus as recited in claim 6, wherein the second basic element includes a cut-out, and wherein the latching element is connected to the first basic element so as to be axially movable and rotationally fixed relative to the pivot axis and configured to enter a positive connection with the cut-out.

12. The apparatus as recited in claim 6, wherein the latching element includes a plurality of recesses and the cut-out includes a latching boss.

13. The apparatus as recited in claim 1, wherein the integrated latching device is disposed at a region of a first end of the pivot axis and further comprising a further latching device disposed at a second end of the pivot axis opposite the first end, wherein a latching element of each latching device is actuatable by a compressive force acting in opposite directions.
